(19) United States
(12) Patent Application Publication
(10) Pub. No.: US 2002/0112866 A1
(43) Pub. Date: Aug. 22, 2002

(54) Self-resetting impact device

(76) Inventors: Mark Buyers, Dyce (GB); Simon Benedict Fraser, Dyce (GB); David Forsythe, Dyce (GB)

Correspondence Address: MADSON & METCALF, GATEWAY TOWER WEST, SUITE 900, 15 WEST SOUTH TEMPLE, SALT LAKE CITY, UT, 84101

(21) Appl. No.: 09/785,792

(22) Filed: Feb. 16, 2001

(51) Int. Cl. B25D 11/00

(52) U.S. Cl. 173/91

(57) ABSTRACT

A self-resetting impact device for use in a wellbore in order to jar a downhole tool or piece of equipment, said mechanism being attachable to a line e.g. a wireline so as to be lowerable to a required location in the wellbore, and said device comprising: means for attaching the device to a line; a housing; a hammer rod slidable relative to the housing in order to carry out a hammer stroke so as to apply an impact load; a releasable lock for holding the housing and the rod in a predetermined relative position, said lock being releasable upon application of a predetermined upward load to the device via said line so that a hammer stroke can take place; and, a reset arrangement for returning the body and the housing to the predetermined position after completion of the hammer stroke.

This invention relates to a self-resetting impact device for use with a wireline tractor in a wellbore.

### BACKGROUND TO THE INVENTION

In the petrochemical industries, oil, gas and water wells allow the extraction of products from below the surface of the earth. Gas and water wells allow injection of products for storage or to assist in the recovery from producing oil and gas wells etc.

The wells may be drilled to a great depth and are periodically cased with a large diameter metal pipe in order to avoid collapse of the newly drilled hole. The final section of the well may be cased or left open depending on the characteristics of the rock at that point. The final reaches of the well are obviously the deepest and because of ambient hydrostatic pressures are usually the highest pressure.

The wells are normally completed with a pressure sealing conduit called “tubing” which runs from the wellhead or xmas tree valve assembly on surface to near the bottom of the well. Both ends are sealed in order to provide a pressure tight communication between the surface facilities and the producing formation.

In oil, gas and water wells, various interventions are required from time to time to perform well servicing operations. These may take the form of plugging off the lower section of the well in order to safely work on the upper section, introducing a pressure barrier in the wellbore, closing off a section of the wellbore, opening a sleeve to allow communication to a different section of the wellbore or other operations.

The most common and cost effective method of performing these tasks is a technique called wireline or slickline. A device or tool is conveyed into the wellbore on the end of a single strand solid wire. The wire is spooled off a winch assembly which contains a mechanism for measuring length (depth) and the weight of the wire. The wire is pressure sealed at surface allowing this operation to happen whilst there is pressure within the tubing.

Many tools of different types may be conveyed into the wellbore to perform a variety of tasks. Once these tools have been lowered to their required depth they may have to be manipulated to fit into profiles which exist within the tubing and which were put there for that purpose. In order for these tools to operate, to seal pressure, to engage with the profiles and other tasks, simple manipulation alone is not enough. Devices called “jars” exist to assist in the positioning or removal of these tools. Various types of jars exist but all work on the slide hammer principle whereby a mass is accelerated along a fixed distance and impacted in order to create a sudden large force. In this way, greater forces than the pull of the wire or the weight of the tools may be imparted to assist in the operation of the tools.

The original (and most common) type of wireline jar is called a spang jar. This has the appearance of two large chain links joined together in order that the assembly may extend or collapse as required. Above this are weight bars which when raised or lowered deliver the impact through the jars to the tool below. Spang jars rely on gravity to return the hammer and weight bars to the initial bottom position when jarring up, and on gravity to accelerate the weights and hammer downwards when jarring down. When jarring down, the winch pulling on the wire and weights will return them to the top initial position until released.

### SUMMARY OF THE INVENTION

According to the invention there is provided a self-resetting impact device for use in a wellbore in order to jar a downhole tool or piece of equipment, said mechanism being attachable to a line e.g. a wireline so as to be lowerable to a required location in the wellbore, and said device comprising:

means for attaching the device to a line;

a housing;

a hammer rod slidable relative to the housing in order to carry out a hammer stroke so as to apply an impact load;

a releasable lock for holding the housing and the rod in a predetermined relative position, said lock being releasable upon application of a predetermined upward load to the device via said line so that a hammer stroke can take place; and,

a reset arrangement for returning the body and the housing to the predetermined position after completion of the hammer stroke.

Preferably, the device is adapted to have a weight coupled therewith, to assist the activation and / or operation of the device.

The reset arrangement may comprise a return or resetting spring.

Preferably, a hydraulic restrictor is incorporated within the device to provide resistance to relative movement of the body and the hammer rod, and which may provide a preliminary resistance while tensile energy is stored in the line, and which then initiates release of the lock so that a high energy impact force is applicable to the hammer rod.

The releasable lock may comprise at least one release key engageable with an abutment in the housing to define the predetermined position of the housing and the hammer rod.

To apply a predetermined impact or jarring load, the hammer rod may carry an impact surface which is engageable with an impact surface of the housing when the hammer rod has completed its hammer stroke.

The device according to the invention is preferably adapted for use in combination with a wellbore tractor. This enables the device to be used in highly deviated wells e.g. at 70° or 80° to the vertical, or even along horizontal wellbore sections, and when, preferably, any additional weights operating in combination with the device assist the jarring operation.

### DESCRIPTION OF PREFERRED EMBODIMENTS

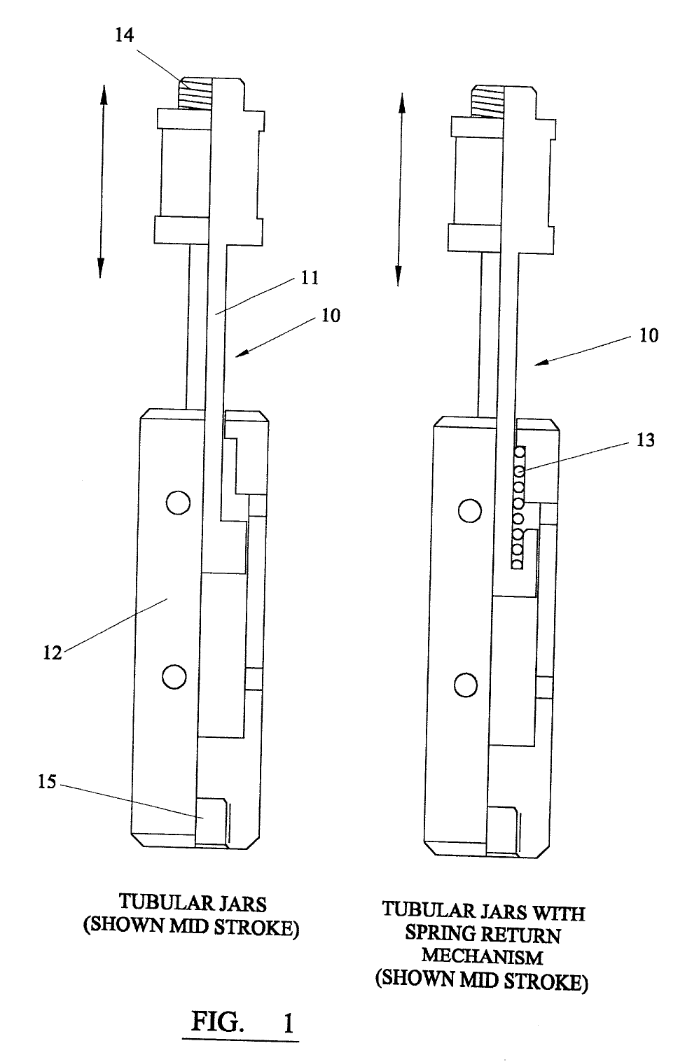

Preferred embodiments of self-resetting impact mechanism according to the invention will now be described, by way of example only, with reference to FIGS. 1 to 4 of the accompanying drawings.

The embodiments shown in FIGS. 1 to 4 are examples of self-resetting impact device according to the invention, for use with a wireline tractor in a wellbore, and having a housing, means for attaching the device to a line e.g. a wireline so as to be lowerable to a required location in the wellbore, and a hammer rod slidable relative to the housing in order to carry out a hammer stroke so as to apply an impact load.

There is also provided a releasable lock for holding the housing and the rod in a predetermined relative position, the lock being releasable upon application of a predetermined upward load to the device via the line so that a hammer stroke can take place. Finally, there is a reset arrangement for returning the body and the housing to the predetermined position after completion of the hammer stroke.

Referring first to FIG. 1 of the drawings, there is shown a so-called “tubular jar” which forms generally the same function as a spang jar, and designated generally by reference 10. It comprises a stepped hammer rod 11 in a stepped internal diameter tube (anvil cylinder) 12 with a hammer and an anvil contact surface preventing separation of the two. There is a degree of separation between the two allowing the rod (hammer) to impact the tube. Tubular jars allow upwards and downwards jarring and are normally used where junk may impede the movement of spang jars. Tubular jars rely on gravity to return the hammer and weight bars to the initial bottom position, when jarring up, and on gravity to accelerate the weights and hammer downwards when jarring down. When jarring down, the winch pulling on the wire and weights will return them to the top initial position until released. A variety of tubular jar exists featuring an insulated wire running through the jar. This jar is suited to electric wireline operations and may be used when electronic devices below the jar become stuck in a wellbore. The jar 10 also has a return spring 13, a top connection 14 and a bottom connection 15.

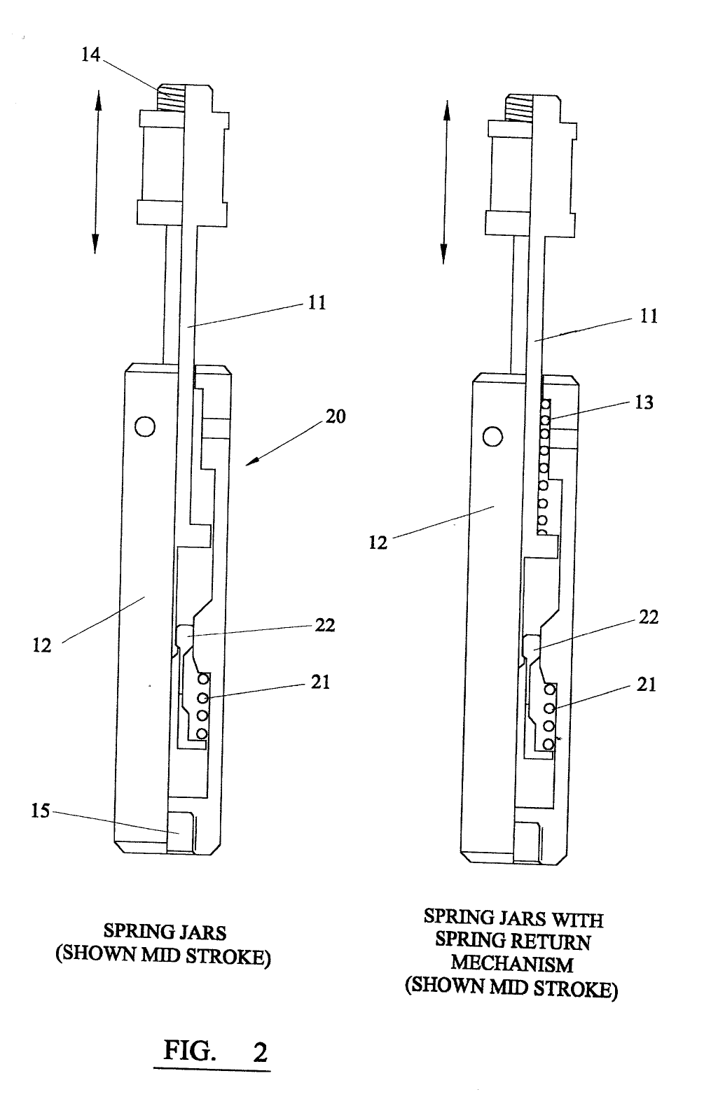

Referring to FIG. 2, this shows a “spring jar”, which is a modified form of tubular jar, and shown generally by reference 20. Spring jars will only function when jarring upwards. The rod 11 is retained by a strong jar spring 21 allowing a large amount of energy to be stored in the wire as the pulling force from surface is gradually increased. At a certain set point, the force of the retaining spring is equalled allowing the spring to be compressed. At a second point, trip keys 22 disengage the rod allowing all the stored energy in the wireline to be directed to accelerating the rod/hammer and weights above towards the anvil. This technique allows a much greater impact force than spang or tubular jars. This jar is reset by slacking off the wire and allowing gravity to return the rod to its normal relaxed position where it may engage the spring via the trip/locking mechanism.

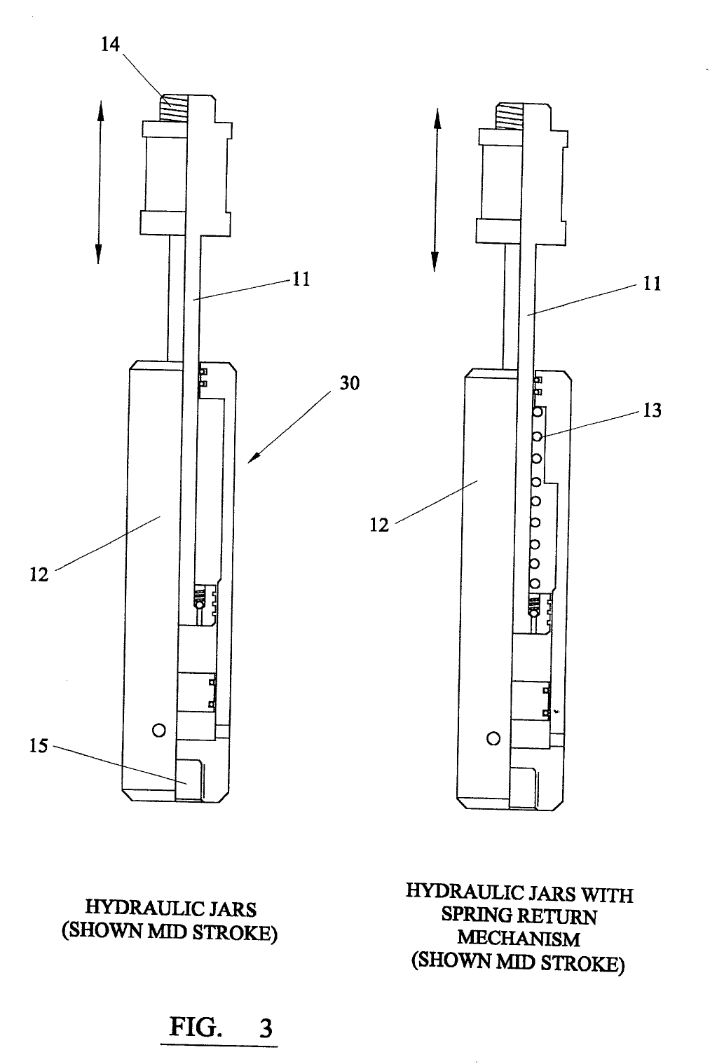

Referring to FIG. 3, this shows a hydraulic jar 30, which is similar to a spring jar and also will only function when jarring upwards. Hydraulic jars feature an hydraulic chamber with a piston assembly linked to the wire by the rod and weights. Where spring jars can only output the energy which is stored in the wire regulated by the strength of spring, hydraulic jars work on a time delay principle. The hydraulic chamber allows oil to meter from above to below the piston when tension is applied to the wire. The wire may be charged to the maximum safe tension on surface and held whilst the jar meters oil. After a set volume of oil has metered, the hydraulic lock which existed is released and the tool hammer section is released. The great spring force stored in the wire is actuated and this accelerates the weights and hammer to hit with the anvil section imparting a great blow. The tool is reset by releasing the wire and allowing gravity to return the moving portion of the jar back to its relaxed position. A non return valve in the piston allows rapid movement of hydraulic fluid back to the starting point.

Other jars exist which offer combinations, variations and features of the previously detailed types. Presently, all jars rely on gravity for at least a part if not all of their operation.

As borehole technology advances and new techniques develop, boreholes are becoming deeper and are increasingly becoming deviated to a greater angle. This is to allow more wells to be positioned from a central drilling site, to increase the area of drainage and to reach isolated outlying pockets. In some wells, a single vertical wellbore section may branch out into a number of laterals for reasons of economics. The laterals are usually at a great angle to the vertical. Many new wells feature a horizontal section in order to increase productivity.

Because of the reduced gravity effects in deviated wellbores, conventional wireline techniques become increasingly difficult. At angles of more than 60° special techniques including centralisers and rollers are required, but conventional wireline is impossible in horizontal wells. In short, wells exist where the reliance on gravity for tool operation is no longer possible.

Recent developments in well servicing technology have seen the introduction of tractors which may be run on wireline. Tractors have the ability to advance along horizontal and highly deviated wellbores pushing tools ahead of them. Conventional jar type tools may be used only once at best in the types of environment as described above because the jars cannot be prepared or primed by gravity.

It is the intention of the invention to remove the reliance on gravity such that jarring operations (and others) may proceed on high angle and horizontal wellbores. Inclusion of a spring of a strength sufficient to re-cock the mechanism but sufficiently rated such that it may not significantly impede the jarring operation is required in all cases (see FIGS. 1, 2 and 3). It is also the intention that this invention may be used between the wireline and a tractor in the event that the tractor becomes stuck, allowing increased force to be used to free the tractor.

The embodiments of the invention described above and illustrated in FIGS. 1 to 3 comprise examples of selfresetting impact mechanism according to the invention, for use with a wireline tractor, in a wellbore.

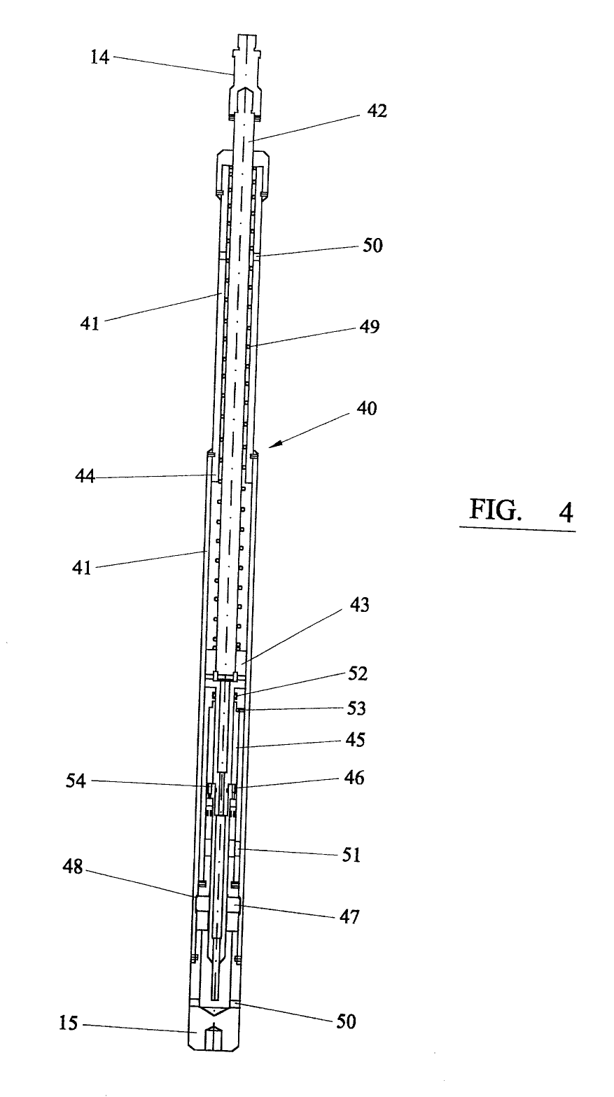

Referring now to FIG. 4 of the drawings, a further embodiment is designated generally by reference 40, and comprises tubular housing 41, a hammer rod 42 longitudinally slidable relative to housing 41, an impact surface 43 carried by the hammer rod 42, and an impact surface 44 carried by the housing 41 and engageable by impact surface 43 at the end of the hammer stroke, to apply an impact or jarring load. A hydraulic chamber 45 is defined within the housing 41, and upon application of a tensile load to the line (not shown) connected to the device 40, while in the chamber 45 meters through a hydraulic restrictor or choke 46, and this is designed to take about 20 seconds, which allows the line e.g. a wireline to be stretched, and stored with tensile energy up to its maximum safe limit, typically about 1,000 lbs. As the oil meters through the restrictor 46, the central rod 42 rises relative to the housing 41, and this causes release keys 47 to disengage from an abutment 48 provided in the housing 41, and to move upwardly until the keys drop into the reduced diameter portion of the housing 41. This disconnects all the internal components from the casing, allowing the stored energy in the wire to accelerate the central rod (and weights fitted above the device or tool 40) upwards to the impact point creating the jarring effect. A large resetting spring 49 is charged at this time (typically with 200 lbs solid load), allowing the tool to re-cock when the wire is slackened off.

The tool 40 also has vent hole 50, a vent port 51, O-ring 52, filling valve 53 and non-return valve 54. A floating piston 55 is also slidably mounted within the lower part of housing 41, and the purpose of this is to serve for well pressure compensation.

Having described and illustrated preferred embodiments of the invention, the invention will now be defined in more general terms.

Accordingly, in a first aspect of the invention, there is provided a wireline jar assembly utilising a return mechanism arranged to prime the jar by biasing the jar to the initial or relaxed position prior to and after the impact blow when wire tension has been released in order to obviate the need for gravity to prepare the jar for the next blow.

In a further aspect of the invention, there is provided a spang jar assembly utilising a spring mechanism arranged to prime the jar by biasing the jar to the initial or relaxed position prior to and after the impact blow when wire tension has been released in order to obviate the need for gravity to prepare the jar for the next blow.

In a preferred arrangement of jar assembly, in the form of a tubular jar assembly, a spring mechanism is utilised which is arranged to prime the jar by biasing the jar to the initial or relaxed position, prior to and after the impact blow, when wire tension has been released, in order to obviate the need for gravity to prepare the jar for the next blow.

In a preferred arrangement of spring jar assembly as defined above, a spring mechanism is utilised which is arranged to prime the jar by biasing the jar to the initial or relaxed position, prior to and after the impact blow, when wire tension has been released, in order to obviate the need for gravity to prepare the jar for the next blow.

The invention may be applied to a hydraulic jar assembly which also utilises a spring mechanism arranged to prime the jar by biasing the jar to the initial or relaxed position, prior to and after the impact blow, when wire tension has been released, in order to obviate the need for gravity to prepare the jar for the next blow.

A jar assembly as defined above, and optionally with any of the preferred features, is incorporated in or combined with a wireline tractor type of tool.

Alternatively, a jar assembly as defined above may be incorporated in a separately conveyed downhole assembly which may be actuated by a wireline.

The jar assembly may feature insulated connections, top and bottom, and with insulated continuity through the tool such that it becomes suitable for use on electric wireline.

We Claim

1. A self-resetting impact device for use in a wellbore in order to jar a downhole tool or piece of equipment, said mechanism being attachable to a line e.g. a wireline so as to be lowerable to a required location in the wellbore, and said device comprising:
means for attaching the device to a line;
a housing;
a hammer rod slidable relative to the housing in order to carry out a hammer stroke so as to apply an impact load;
a releasable lock for holding the housing and the rod in a predetermined relative position, said lock being releasable upon application of a predetermined upward load to the device via said line so that a hammer stroke can take place; and,
a reset arrangement for returning the body and the housing to the predetermined position after completion of the hammer stroke.

2. A device according to claim 1, and which is adapted to have a weight coupled therewith, to assist the activation and/or operation of the device.

3. A device according to claim 1, in which the reset arrangement comprises a return spring.

4. A device according to claim 1, in which a hydraulic restrictor is provided in the device to provide resistance to relative movement of the body and the rod.

5. A device according to claim 4, in which the hydraulic restrictor is arranged to provide a preliminary resistance while tensile energy is stored in the line, and which then initiates release of the lock so that a high energy impact force is applicable to the hammer rod.

6. A device according to claim 1, in which the releasable lock comprises at least one release key engageable with an abutment in the housing to define said predetermined position of the housing and the hammer rod.

7. A device according to claim 6, in which the hammer rod carries an impact surface which is engageable with an impact surface of the housing when it has completed its hammer stroke.

8. A device according to claim 1, and adapted for use in combination with a wellbore tractor.

9. A wireline jar assembly utilising a return mechanism arranged to prime the jar by biasing the jar to the initial or relaxed position prior to and after the impact blow when wire tension has been released, in order to obviate the need for gravity to prepare the jar for the next blow.

10. A spang jar assembly utilising a spring mechanism arranged to prime the jar by biasing the jar to the initial or relaxed position prior to and after the impact blow when wire tension has been released in order to obviate the need for gravity to prepare the jar for the next blow.

11. A hydraulic jar assembly which utilises a spring mechanism arranged to prime the jar by biasing the jar to the initial or relaxed position, prior to and after the impact blow, when wire tension has been released, in order to obviate the need for gravity to prepare the jar for the next blow.
